(19) United States
(12) Patent Application Publication
(10) Pub. No.: US 2023/0225557 A1
(43) Pub. Date: Jul. 20, 2023

(54) CAMPFIRE COOKING IMPLEMENT STORAGE AND CLEANING APPARATUS

(71) Applicant: George Layton Pickard, V, Coleman, MI (US)

(72) Inventor: George Layton Pickard, V, Coleman, MI (US)

(21) Appl. No.: 18/098,644

(22) Filed: Jan. 18, 2023

Related U.S. Application Data
(60) Provisional application No. 63/300,311, filed on Jan. 18, 2022.

(51) Int. Cl. A47J 37/07; F16M 13/02; A47G 29/087; A46B 9/02; A46B 17/02; A47L 17/00

(52) U.S. Cl. CPC A47J 37/0786; A46B 9/02; A46B 17/02; A47G 29/087; A47L 17/00; F16M 13/022; A46B 2200/3073

(57) ABSTRACT

An apparatus includes structure defining a chamber containing brushes with bristles. The chamber has an opening that, in use, is at the top of the structure so that the chamber is upwardly-open. The chamber and opening are sized so that the prongs of a roasting utensil are insertable into the chamber to be scrubbed by the brushes and so that the brushes support the roasting utensil in an upright position for efficient and safe storage when not in use.

### CROSS-REFERENCE TO RELATED APPLICATION

This application claims the benefit of U.S. Provisional Pat. Application No. 63/300,311, filed Jan. 18, 2022, and which is hereby incorporated by reference in its entirety.

### TECHNICAL FIELD

This disclosure relates to utensils for holding food adjacent to a campfire or other outdoor fire for roasting.

### BACKGROUND

Campers sometimes use the heat from campfires to roast food such as hot dogs and marshmallows. To roast food, the food must be in sufficient proximity to the fire to receive adequate heat. However, the campers must maintain enough distance to avoid the negative effects of heat on their skin. To hold the food close to the fire while maintaining their hands at a sufficient distance from the fire to avoid burns or discomfort, various utensils, sometimes referred to as “roasting sticks” or “roasting forks” are employed.

These roasting utensils include a shaft having a grip or handle at one end and a food retention portion at the other end opposite the grip or handle. In most cases, the food retention portion is either a sharp end or a bifurcated fork on which the food is skewered, as understood by those skilled in the art. The shaft separates the food retention portion (which retains the food) from the grip (at which the camper holds the utensil) so that when the food retention portion and food are close enough to the fire for roasting, the grip and hand is far enough away to avoid burns or discomfort.

The roasting utensils are therefore, of necessity, long and have one or more sharp points at one end. This geometry and size makes roasting utensils cumbersome to store and clean. When not in use, the utensils are stored unhygienically on the ground or take up significant space on a picnic table, with the sharp skewer portions creating a poking hazard. If the utensils have been used, food residue on the food retention portions may also soil clothing or other surfaces that may come into contact with it.

### SUMMARY

A roasting utensil holder is provided. The roasting utensil holder includes structure defining a chamber and an opening to the chamber. The roasting utensil holder also includes a plurality of brushes. Each of the brushes includes a respective central shaft having a plurality of bristles mounted thereto and extending substantially radially therefrom. The brushes are mounted to the structure such that the brushes extend across the chamber. A clamp is mounted to the structure.

The clamp enables the selective attachment of the holder to various objects that may be found around a campfire, such as a picnic table or folding camp chair. The roasting utensil holder is configured such that, when the clamp is engaged with the picnic table, camp chair, etc., the opening to the chamber is facing upward.

The opening to the chamber is sufficiently sized such that the food retention portion of a roasting utensil is insertable into the chamber through the opening. The central shafts of the brushes and the structure defining the chamber cooperate to limit lateral movement of the food retention portion such that the utensils are maintained in a substantially upright (i.e., vertical) position.

The bristles extend through the space within the chamber between the central shafts and the structure; insertion of the food retention portion of the utensil into the chamber causes contact between the bristles and the food retention portion, thereby causing the bristles to scour the food retention portion and remove unwanted food residue. In one embodiment, the structure is formed by two pieces that are detachable from one another to expose the brushes for even more effective scouring of the utensils.

Accordingly, the roasting utensil holder provides a secure and stable place to store roasting utensils when not in use, and also provides a way to clean the roasting utensils.

A corresponding method of use is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, side view of a holder for supporting and cleaning roasting sticks;

FIG. 2 is a schematic, top view of the holder;

FIG. 3 is a schematic, perspective view of the holder;

FIG. 4 is a schematic, cross-sectional view of the holder;

FIG. 5 is a schematic, side view of the holder partially disassembled;

FIG. 6 is a schematic, perspective view of the holder attached to a picnic table and holding a roasting stick;

FIG. 7 is a schematic, top view of the holder attached to the picnic table and holding the roasting stick;

FIG. 8 is a schematic, perspective view of the holder attached to a camp chair and holding two roasting sticks;

FIG. 9 is a schematic, perspective view of the clamp assembly of the holder in an open configuration; and

FIG. 10 is a schematic, perspective view of the clamp assembly in a closed configuration.

### DETAILED DESCRIPTION

Referring to the Figures, wherein like reference numbers refer to like components throughout, a holder 10 for use with roasting utensils 14 is schematically depicted. The holder 10 includes structure 18 that defines an open space, which, in the embodiment depicted, is a chamber 22 having an opening 26. More specifically, in the embodiment depicted, the structure 18 has five walls 30A, 30B, 30C, 30D, 30E.

Walls 30A and 30B are substantially parallel to one another; walls 30C and 30D are substantially parallel to one another and perpendicular to walls 30A and 30B; and wall 30E is perpendicular to walls 30A, 30B, 30C, and 30D. Walls 30C, 30D, and 30E extend between, and interconnect, walls 30A and 30B. The walls 30A-E cooperate to define the chamber 22. The structure 18 as shown in the Figures is in the shape of a rectangular prism, though other shapes and structure configurations may be employed within the scope of the claimed invention. The opening 26 to the chamber 22 is directly opposite wall 30E.

The holder 10 includes a plurality of brushes 34. Each of the brushes 34 includes a respective central shaft 38 and a plurality of bristles 42 that are connected to the central shaft 38 such that the bristles 42 extend radially outward from the shaft 38. The brushes 34 are mounted to the structure 18 such that the brushes 34 extend across the chamber 22. In the embodiment depicted, each of the central shafts 38 extends from wall 30C to wall 30D such that the central shafts 38 are parallel to one another. In the embodiment depicted, the brushes 34 are mounted to the walls 30C, 30D with threaded fasteners 44 that extend through holes in the walls and the central shafts, though any method of mounting the brushes 34 to the structure 18 may be employed within the scope of the claimed invention.

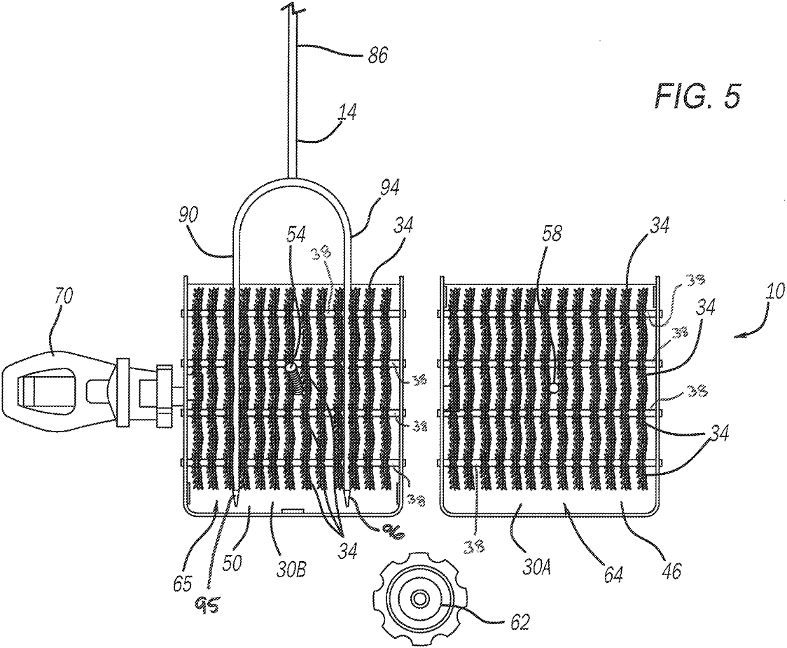

In the embodiment depicted, the structure 18 is formed from two segments 46, 50 to assist in assembly of the holder 10. The segments 46, 50 are also selectively separable to facilitate access to the brushes 34 for cleaning. More specifically, segment 46 includes wall 30A and half of walls 30C, 30D, 30E. Segment 50 includes wall 30B and half of walls 30C, 30D, 30E. The segments 46, 50 are separable as shown in FIG. 5 to make the brushes 34 more accessible.

The holder 10 includes a fastening system to fasten the segments 46, 50 together to form the chamber 22. In the embodiment depicted, the fastening system includes a threaded rod 54 that is attached to segment 50 at wall 30B. A hole 58 in wall 30A is positioned so that the rod 54 extends therethrough when the segments 46, 50 are positioned to form the rectangular prism, as best seen in FIG. 4; a nut 62 having internal threads is engageable with the threaded rod 54 and contacts the wall 30A, thereby connecting the segments 46, 50. It should be noted that other fastening systems to releasably connect the segments 46, 50 may be employed within the scope of the claimed invention.

It should be noted that, in the embodiment depicted and as best shown in FIGS. 4 and 5, a first set 64 of brushes 34 is connected to the portions of the walls 30C, 30D that are formed by segment 46, and a second set 65 of brushes is connected to the portions of the walls 30C, 30D that are formed by segment 50. Thus, each segment 46, 50 has a respective set 64, 65 of brushes 34 mounted thereto. The central shafts 38 of the first set 64 of brushes 34 are parallel to one another and coplanar on a first plane 66 that is parallel to walls 30A, 30B. The central shafts 38 of the second set 65 of brushes 34 are parallel to one another and coplanar on a second plane 68 that is parallel to plane 66.

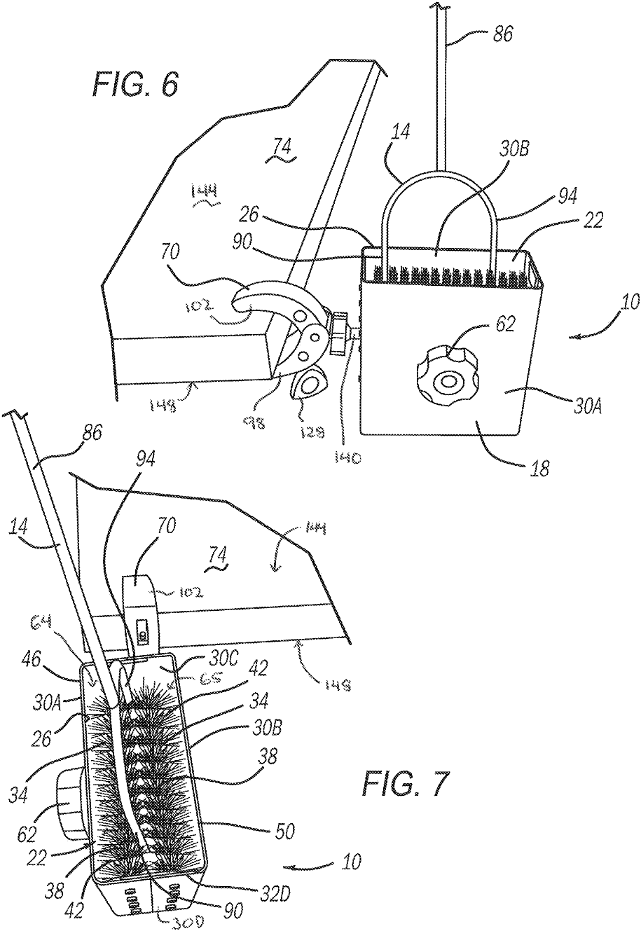

The holder 10 includes a clamp assembly 70 that is mounted to the structure 18. The clamp assembly 70 is configured to removably attach the holder 10 to various outdoor objects or furniture that may be at a campsite or near a campfire, including, but not limited to, a picnic table 74, the leg 78 of a portable camp chair 82, etc. The clamp assembly 70 may be any type of clamp suitable for releasably attaching the holder 10 to a picnic table top 74, a cylindrical camp chair leg, etc. within the scope of the claimed invention. The clamp assembly 70 is selectively rotatable relative to the structure 18 and the brushes 34 so that the clamp assembly 70 can engage objects of various shapes and orientations while maintaining the structure 18 in a position in which the opening 26 is at the top of the structure 18 and the chamber 22 is upwardly open, as shown in FIGS. 6-8.

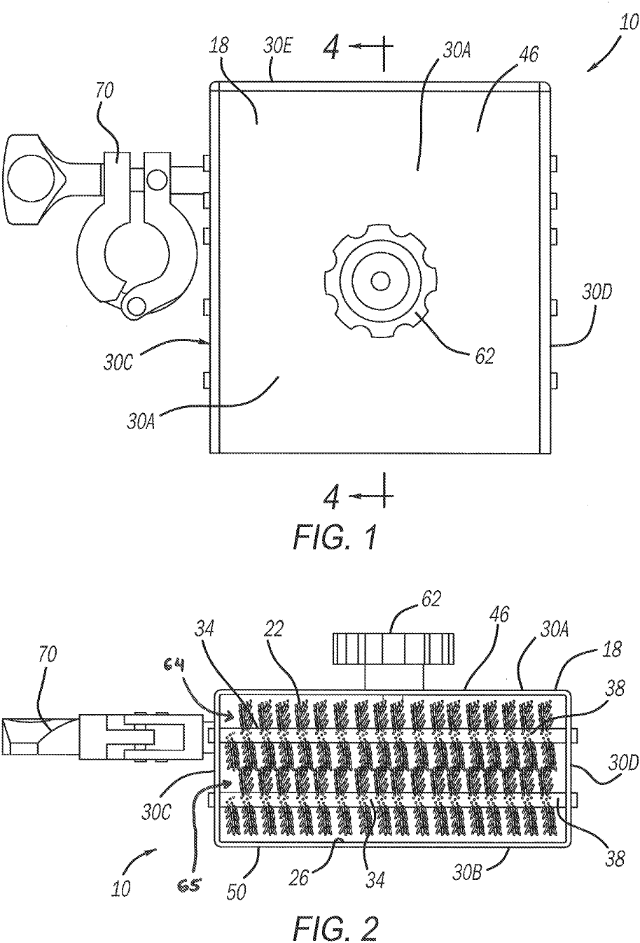

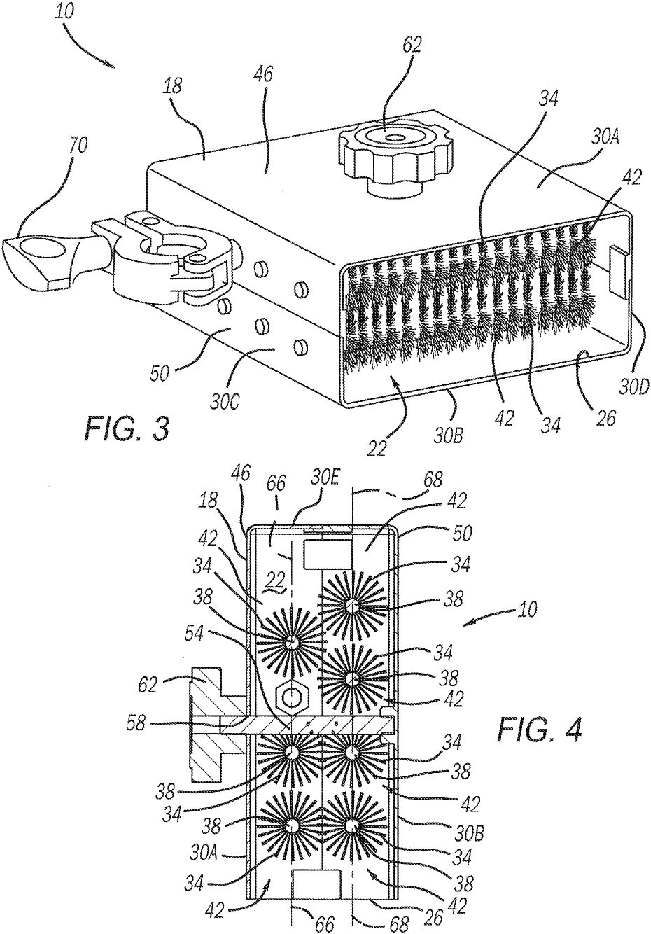

A method of using the holder 10 may include operatively connecting segments 46, 50 to one another so that they cooperate to form a rectangular prism and define chamber 22, as shown in FIGS. 1-4 and 6-8. Operatively connecting the segments 46, 50 may include extending the threaded rod 54 that is attached to segment 50 through the hole 58 in wall 30A, and then engaging nut 62 with the threaded rod 54 so that the nut 62 contacts the wall 30A.

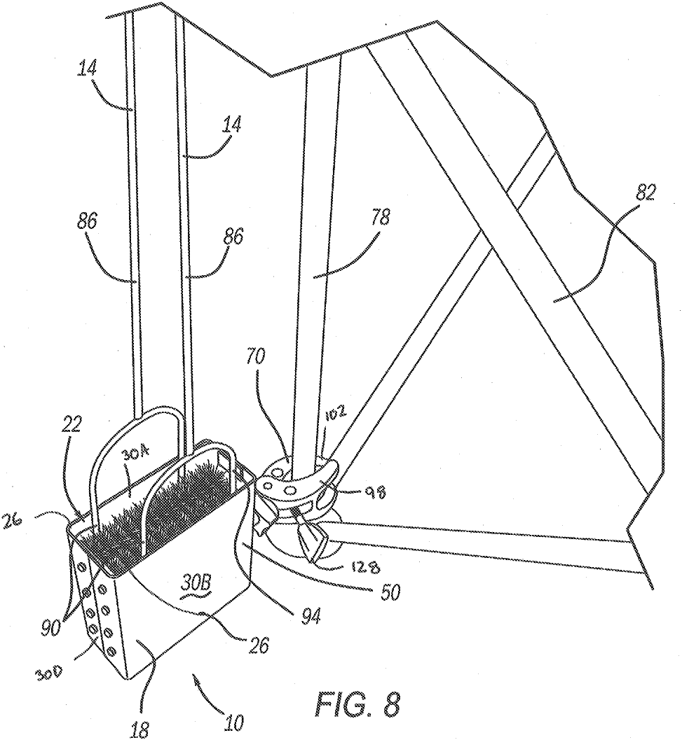

The method also includes using the clamp assembly 70 to attach the holder 10 to an object at a campsite or near a campfire, and, more specifically, to cause the assembly 70 to clamp, i.e., exert compressive clamping forces on, the object. The object may be a picnic table 74, as shown in FIGS. 6 and 7, or the leg 78 of a camp chair 82, as shown in FIG. 8. The method may also include rotating the structure 18 (and the brushes 34 mounted thereto) relative to the clamp assembly 70 so that the opening 26 to the chamber 22 is at the top of the structure 18 and the chamber 22 is open and unobstructed from above.

The method further includes inserting the food retention portion of a roasting utensil 14 through the opening 26 and into the chamber 22, as shown in FIGS. 7 and 8. In the embodiment depicted, the utensil 14 includes a shaft 86, and the food retention portion attached at one end of the shaft 86 is a fork having two prongs 90, 94; each prong 90, 94 has a respective terminal end 95, 96 that is tapered to form a conical tip. A grip or handle (not shown) is mounted to, or integral with, the shaft 86 at the end opposite the prongs 90, 94 as understood by those skilled in the art.

When the prongs 90, 94 have been sufficiently inserted into the chamber 22, the bristles 42, the shafts 38, and/or the walls 30A, 30B will prevent or restrict lateral movement of the prongs 90, 94, which will maintain the shaft 86, which remains outside the chamber 22, in a substantially upright, vertical position. More specifically, the bristles 42, shafts 38, and/or walls 30A, 30B act on the prongs 90A, 90B to prevent the utensil 14 from falling to a horizontal position. This upright position of the shaft 86 provides efficient storage of the utensils 14 until they are ready to use.

The use of two sets 64, 65 of brushes enables the storage of a plurality of utensils 14, as shown in FIG. 8. Referring specifically to FIG. 8, the prongs 90, 94 of a first utensil 14 are between wall 30A and the shafts 38 of the first set 64 of brushes 34; the wall 30A and the first set 64 of brushes 34 restrict movement of the prongs 90, 94 of the first utensil 14. The prongs 90, 94 of a second utensil 14 are between wall 30B and the shafts 38 of the second set 65 of brushes 34; the wall 30B and the second set 65 of brushes 34 restrict movement of the prongs 90, 94 of the second utensil 14. As shown in FIG. 7, the prongs 90, 94 of a utensil 14 are also insertable between the first and second sets 64, 65 of brushes 34 such that the shafts 38 of the two sets 64, 65 of brushes restrict lateral movement of the utensil. Accordingly, in the embodiment depicted, the holder 10 can store at least three utensils 14.

As the prongs 90, 94 move through the chamber 22, the bristles 42 scour the prongs 90, 94, thereby removing food residue. The method may include moving the utensils 14 up and down repeatedly to increase the scouring action.

The method may also include separating the segments 46, 50 as shown in FIG. 5 to expose the brushes 34 for cleaning the brushes 34. It should be noted that the structure 18 may have other configurations within the scope of the claimed invention. For example, the walls 30A, 30B, 30C, 30D may have holes to reduce the weight of the holder 10 or to facilitate the removal of water or residue from the chamber 22. In one embodiment, the bristles 42 are metal.

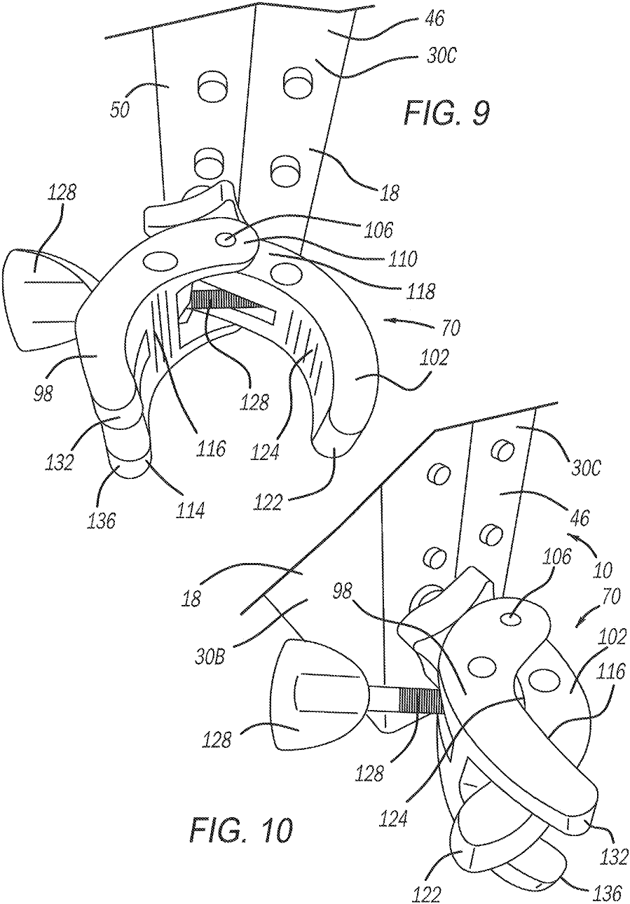

It should be noted that the clamp assembly 70 is shown highly schematically in FIGS. 1-5. FIGS. 9 and 10 schematically depict the clamp assembly 70. Clamp assembly 70 includes first and second jaw members 98, 102 that are pivotably connected to each other via a pivot pin 106. More specifically, jaw member 98 includes an end 110 that is proximate to the pivot pin 106, an end 114 that is distal relative to the pin 106, and a concave surface 116 between the ends 110, 114. Similarly, jaw member 102 includes an end 118 proximate to the pin 106, another end 122 distal to the pivot pin 106, and a concave surface 124.

Surfaces 116, 124 generally face each other. The distance between surfaces 116, 124, and the distance between ends 114, 122, are variable by causing jaw member 98 to rotate relative to jaw member 102 about the pivot pin 106. Accordingly, a compressive clamping force is exertable by the jaw members 98, 102 on an object located between the surfaces 116, 124, or between the ends 114, 122, as understood by those skilled in the art.

The clamp assembly 70 includes a thumb screw 128 having external threads. The thumb screw 128 extends through a hole in the first jaw member 98 having internal threads. The external threads and the internal threads engage each other such that rotation of the thumb screw 128 causes rotation of the first jaw member 98 about the pivot pin 106 and relative to the second jaw member. Thus, a user of the holder 10 attaches the holder 10 to an object, e.g., the picnic table or camp chair, by positioning the object between the jaw members 98, 102 when the jaw members 98, 102 are in an open position as shown in FIG. 9, and turning the thumbscrew 128 until a sufficient compressive clamping force is exerted on the object. FIG. 10 depicts the clamp assembly with the jaw members 98, 102 fully closed.

The surfaces 116, 124 may have a high-friction coating applied thereto to prevent the holder 10 from sliding along the object to which it is attached. In the embodiment depicted, end 114 is bifurcated into two prongs 132, 136. When the jaw members 98, 102 are fully closed, as shown in FIG. 10, the end 122 of jaw member 102 extends between the prongs 132, 136 of jaw member 98 to permit the surfaces 116, 124 to be closer together.

Although a thumb screw style clamp assembly 70 is shown and described, it should be noted that any clamp configuration suitable for attaching the holder 10 to an object may be employed within the scope of the claimed invention.

The clamp assembly 70 is connected to the structure 18 via a shaft 140. The clamp assembly 70 is selectively pivotable about the shaft 140 such that the orientation of the clamp assembly 70 can be altered while maintaining the structure 18 so that the chamber 22 is upwardly-open. For example, and with reference to FIGS. 6 and 7, the picnic table top 74 has first and second horizontal surfaces 144, 148. Surface 144 faces upward and surface 148 faces downward, as understood by those skilled in the art. The clamp assembly 70 is positioned such that one jaw member 98 contacts the lower surface 148 and the other jaw member 102 contacts the upper surface 144. Thus, the jaw members 98, 102 are coplanar about a vertical plane.

However, the orientation of the clamp assembly 70 shown in FIGS. 6 and 7 will not permit the clamp assembly 70 to clamp onto a vertically-oriented cylinder, such as the leg 78 of the camp chair 82 as shown in FIG. 8. A user may rotate the clamp assembly 70 relative to the structure 18 such that the jaw members 98, 102 are coplanar about a horizontal plane so that the cylindrical outer surface of the leg 78 may be clamped between the jaw members 98, 102. The clamp assembly 70 in FIG. 8 is rotated ninety degrees relative to the structure 18 from its position in FIGS. 6 and 7.

A mechanism may be employed to selectively lock the clamp assembly 70 relative to the structure 18 once the clamp assembly 70 is in its desired rotational position.

While the best modes for carrying out the disclosure have been described in detail, those familiar with the art to which this disclosure relates will recognize various alternative designs and embodiments for practicing the disclosure within the scope of the appended claims.

1. An apparatus for use with a roasting utensil having first and second prongs connected to a shaft, the apparatus comprising:
structure defining a chamber and an opening to the chamber;
a plurality of brushes mounted to the structure and extending across the chamber; and
a clamp assembly mounted to the structure and configured to releasably connect the structure to an object;
the chamber and the opening being sufficiently sized and shaped such that the first and second prongs are insertable into the chamber through the opening.

2. The apparatus of claim 1, wherein the brushes are sufficiently positioned such that the brushes and the structure restrict lateral movement of the first and second prongs, thereby retaining the shaft in a substantially upright and vertical position when the prongs are sufficiently within the chamber and the chamber is upwardly open.

3. The apparatus of claim 2, wherein the plurality of brushes includes a first set of brushes being coplanar about a first plane and a second set of brushes being coplanar about a second plane;
wherein the first plane and the second plane are parallel to one another.

4. The apparatus of claim 3, wherein each of the brushes includes a respective shaft and a plurality of bristles mounted to the shaft.

5. The apparatus of claim 4, wherein the clamp assembly includes first and second jaw members that are configured to exert a compressive force therebetween; and
wherein the clamp assembly is selectively rotatable relative to the structure between a first position in which the jaw members are coplanar in a first plane and a second position in which the jaw members are coplanar in a second plane that is perpendicular to the first plane.

6. A method comprising:
attaching the apparatus of claim 1 to outdoor furniture via the clamp assembly such that the chamber is upwardly open; and
inserting the first and second prongs into the chamber through the opening so that the apparatus restricts lateral movement of the first and second prongs.

7. The method of claim 6, wherein the outdoor furniture is a picnic table.

8. The method of claim 6, wherein the outdoor furniture is a chair.

9. The method of claim 6, wherein said brushes include bristles; and
wherein said inserting the first and second prongs causes the bristles to scrape prongs to clean them.
